(19) United States
(12) Patent Application Publication
(10) Pub. No.: US 2008/0186547 A1
(43) Pub. Date: Aug. 7, 2008

(54) HOLOGRAM OPTICAL ELEMENT, METHOD OF FABRICATION THEREOF, AND IMAGE DISPLAY APPARATUS

(75) Inventors: Yoshie SHIMIZU, Ibaraki-shi (JP); Takeshi Endo, Osaka-shi (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS, INC., Tokyo (JP)

(21) Appl. No.: 12/024,431

(22) Filed: Feb. 1, 2008

(30) Foreign Application Priority Data
Feb. 7, 2007 (JP) 2007-027580

(51) Int. Cl. G02B 27/01; G03H 1/26; G02B 5/32

(52) U.S. Cl. 359/13; 359/22; 359/16

(57) ABSTRACT

As a result of the light from a plurality of point light sources located at an identical position being refracted at a surface of a color correction prism at the time of exposure, the chromatic aberration occurring as a result of the light (for example, image light) directed via a refractive surface of the optical system used at the time of reconstruction to the viewer's pupil being refracted at this refractive surface is corrected for. Moreover, at least two of another set of a plurality of point light sources are arranged at such positions as to provide angles of incidence commensurate with the deviation between them of the ratio between exposure wavelength and use wavelength. Thus, even in a case where the ratio between exposure wavelength and use wavelength differs between at least two colors, it is possible to make equal for all colors the angle of diffraction that provides the maximum diffraction efficiency at the hologram optical element at the time of reconstruction, and thereby to correct for color shifting depending on the viewing angle.

This application is based on Japanese Patent Application No. 2007-027580 filed on Feb. 7, 2007, the contents of which are hereby incorporated by reference.

### BACKGROUND OF THE INVENTION

1. Field of the Invention

The present invention relates to a method for fabricating a hologram optical element which involves exposing a hologram photosensitive material to two coherent light beams to thereby form a volume-phase reflection hologram optical element on a substrate. The invention also relates to a hologram optical element fabricated by that fabrication method, and to an image display apparatus employing such a hologram optical element.

2. Description of Related Art

There have conventionally been proposed various image display apparatuses in which, as shown in FIG. 14, a hologram optical element 102 is formed on a substrate 101 so that an image beam from a display element 103 is guided through the substrate 101 and is diffraction-reflected on the hologram optical element 102 so as to be directed to an optical pupil E. These image display apparatuses allow both image light and outside light to be directed via the hologram optical element 102 to the optical pupil E, and thereby enable an viewer to view both a display image and an outside world image in a form superimposed on each other at the position of the optical pupil E.

Generally, in cases where a color hologram is used as the hologram optical element 102, to present the viewer with a satisfactory image, it is necessary to correct for the following aberration: the chromatic aberration occurring as a result of the image beam from the display element 103 being refracted at a refractive surface (for example, the entrance surface 101a) of the substrate 101. In FIG. 14, for easy understanding, the optical paths of R (red), G (green), and B (blue) light are traced backward from the optical pupil E side. In the following description, this aberration is referred to as “type-1 aberration”.

On the other hand, in cases where a hologram photosensitive material 102a is exposed to two light beams, namely a reference beam and an object beam, as shown in FIG. 15A to thereby produce a hologram optical element 102 as shown in FIG. 15B, if the ratio of the exposure wavelength to the use wavelength at the time of reconstruction (the wavelength of the light with which the display element 103 is illuminated at the time of reconstruction) varies, even when, at the time of exposure, the hologram photosensitive material 102a is exposed at the wavefronts at which both the reference and object beams advance along the same optical path for all of R, G, and B, at the time of reconstruction, the angle of diffraction at which the hologram optical element 102 exhibits the maximum diffraction efficiency varies among R, G, and B. This causes color shifting depending on the viewing angle (causes colors different from what they should appear to be viewed depending on the viewing direction). In the following description, this color shifting is referred to as “type-2 aberration”.

In connection with the foregoing, for example, JP-A-2004-219497 proposes a method for fabricating a color hologram optical element according to which separate optical paths are set up for R, G, and B from a laser light source to a hologram photosensitive material and, while a substrate to which the hologram photosensitive material is bonded is moved, the hologram photosensitive material is exposed for R, G, and B one after another via an eccentric lens provided one in each of those optical paths, in order to thereby fabricate a color hologram optical element. It seems that, with this method, the exposure optical systems for R, G, and B respectively can be so set up as to correct for the above-mentioned type-1 and type-2 aberrations both simultaneously.

On the other hand, for example, according to JP-A-2004-325542, with a view to correcting for the chromatic aberration (type-1 aberration) among R, G, and B which occurs at a refractive surface of a transmissive optical element in a viewing optical system (eyepiece optical system), the wavefronts of at least one of the reference and object beams in an exposure optical system are varied among different wavelengths.

More specifically, generally, the point light sources for R, G, and B which are located on the same side as the viewer's pupil (for example, on the reference beam side) are arranged at one point so as to produce identical spherical waves. By contrast, according to what is proposed in JP-A-2004-325542, the point light sources for R, G, and B on the reference beam side are arranged at different positions within the optical pupil plane at the time of reconstruction, and the angle of incidence on the hologram photosensitive material is controlled separately for R, G, and B so as to correct for type-1 aberration (hereinafter “method A”). According to what is proposed in JP-A-2004-325542, a wedge-shaped prism is inserted in the optical paths on the side where complicate wavefronts are produced (for example, on the object beam side) so as to correct for type-1 aberration (hereinafter “method B”).

Inconveniently, however, according to JP-A-2004-219497, it is difficult to accurately adjust the positions of the eccentric lenses in the exposure optical systems designed for different wavelengths and to accurately arrange at the exposure positions for the different wavelengths the substrate having the hologram photosensitive material bonded thereto. Thus, it is difficult to stably produce a holograph combiner. In particular, moving the substrate at the time of exposure may be the main cause for variations in optical performance at the time of mass fabrication of the hologram combiner.

On the other hand, JP-A-2004-325542 is originally intended to correct for type-1 aberration, and attempting to correct for type-2 aberration by the same method causes the following new inconveniences, making satisfactory simultaneous correction for type-1 and type-2 aberrations impossible.

According to method A, correction for type-1 and type-2 aberrations needs to be achieved through the control of the angle of incidence of the light (reference beam) from the point light sources arranged at the optical pupil side. Thus, it is necessary that the angle of incidence on the hologram photosensitive material be adjustable over a wide range. Moreover, if there are large differences in angle of incidence among the reference beams of different wavelengths at the time of exposure, notable color shifting may occur as the viewer moves his eyes up and down, leading to poor image quality.

On the other hand, according to method B, by making different for different wavelengths the angles of diffraction at the refractive surfaces of the prism inserted in the middle of the optical system for producing the object beam, it is possible, indeed, to cancel type-1 aberration. It is rare, however, that the deviations between exposure wavelength and use wavelength in the R, G, and B bands respectively fulfill the relation that can be corrected for with the color dispersion of the prism. Thus, even when the glass material for the prism is optimized, it is difficult to satisfactorily correct for type-2 aberration ascribable to those deviations.

### SUMMARY OF THE INVENTION

The present invention has been devised to overcome the inconveniences discussed above, and it is an object of the invention to provide a method for fabricating a hologram optical element which allows stable mass fabrication of a hologram optical element and which allows satisfactory simultaneous correction for chromatic aberration (type-1 aberration) occurring on a refractive surface in the optical system at the time of reconstruction and color shifting (type-2 aberration) depending on the viewing angle at the time of reconstruction. It is another object of the invention to provide a hologram optical element fabricated by such a fabrication method and an image display apparatus including such a hologram optical element.

To achieve the above objects, according to one aspect of the invention, a method for fabricating a hologram optical element includes: a step (a) of forming a volume-phase reflection hologram optical element on a substrate through exposure of a hologram photosensitive material to a first wavefront of a first coherent light beam and a second wavefront of a second coherent light beam. Here, the first wavefront is produced as a result of light emitted, for a plurality of different exposure wavelengths, from a plurality of point light sources (i) located at an identical position traveling through an optical system including at least one refractive surface. The refractive surface included in the optical system that produces the first wavefront is so designed as to correct for chromatic aberration occurring as a result of light directed to a viewer's pupil being refracted at a refractive surface included in an optical system used at the time of reconstruction. The second wavefront is produced by use of light emitted, for a plurality of different exposure wavelengths, from a plurality of point light sources (ii). At least two of the point light sources (ii) used to produce the second wavefront are arranged at different positions. The point light sources (ii) are so arranged that, as the ratio of the exposure wavelength to the use wavelength at the time of reconstruction differs between colors corresponding to two point light sources (ii) that are arranged at different positions, so the angle of incidence on the hologram photosensitive material differs between light emitted from those two point light sources (ii).

According to the invention, it is possible to stably obtain a hologram optical element that has a simple optical construction suitable for mass fabrication, that allows satisfactory simultaneous correction for two kinds of chromatic aberration, and that offers satisfactory optical performance.

### BRIEF DESCRIPTION OF THE DRAWINGS

These and other objects and features of the present invention will be apparent from the following detailed description of preferred embodiments thereof taken in conjunction with the accompanying drawings, in which:

FIG. 1 is an illustrative diagram showing, with enlargement, a principal portion of a fabrication optical system applicable to a hologram optical element fabrication method according to an embodiment of the invention;

FIG. 2 is a perspective view showing an outline of the construction of a HMD according to the embodiment of the invention;

FIG. 3 is a sectional view showing an outline of the construction of an image display apparatus applied to the HMD;

FIG. 4 is an illustrative diagram showing the spectral intensity characteristics of the light sources of the image display apparatus and of the laser light sources used at the time of exposure;

FIG. 5 is an illustrative diagram showing an outline of the overall construction of the fabrication optical system;

FIG. 6A is an illustrative diagram showing the optical path of the principal ray in the fabrication optical system at the time of exposure;

FIG. 6B is an illustrative diagram showing the optical path of the principal ray at the time of reconstruction;

FIG. 7A is an illustrative diagram showing the optical path of the object beam and the reference beam (RGB) at the time of exposure in the fabrication optical system;

FIG. 7B is an illustrative diagram showing the optical path of the image beam (RGB) at the time of reconstruction;

FIG. 8 is an illustrative diagram showing another example of the construction of the fabrication optical system;

FIG. 9 is an illustrative diagram showing, with enlargement, a principal portion of the fabrication optical system shown in FIG. 8;

FIG. 10 is an illustrative diagram showing the spectral intensity characteristics of the auxiliary LEDs used at the time of reconstruction along with those of the light sources of the image display apparatus and of the laser light sources used at the time of exposure;

FIG. 11 is an illustrative diagram showing an outline of the overall construction of a fabrication optical system applicable to a hologram optical element fabrication method according to another embodiment of the invention;

FIG. 12 is an illustrative diagram showing, with enlargement, a principal portion of the fabrication optical system;

FIG. 13 is an illustrative diagram showing an outline of the overall construction of a fabrication optical system applicable to a hologram optical element fabrication method according to yet another embodiment of the invention;

FIG. 14 is an illustrative diagram schematically showing a principal portion of a conventional image display apparatus;

FIG. 15A is an illustrative diagram showing the optical path of the object beam and the reference beam (RGB) at the time of exposure according to a conventional hologram optical element fabrication method; and

FIG. 15B is an illustrative diagram showing the optical path of the image beam (RGB) at the time of the reconstruction.

### DETAILED DESCRIPTION OF PREFERRED EMBODIMENTS

### First Embodiment

An embodiment of the invention will be described below with reference to the relevant drawings.

### 1. Construction of an HMD

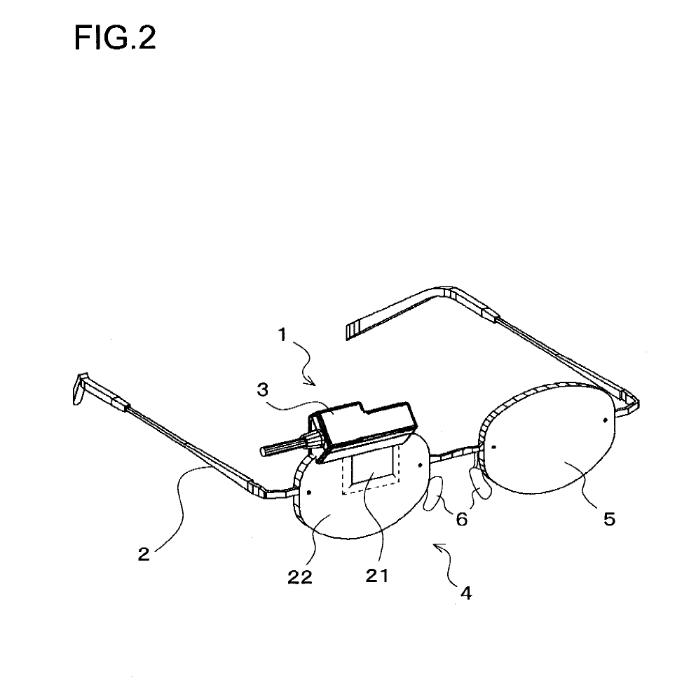

FIG. 2 is a perspective view showing an outline of the construction of an HMD according to the first embodiment. The HMD is composed of an image display apparatus 1 and a supporting member 2.

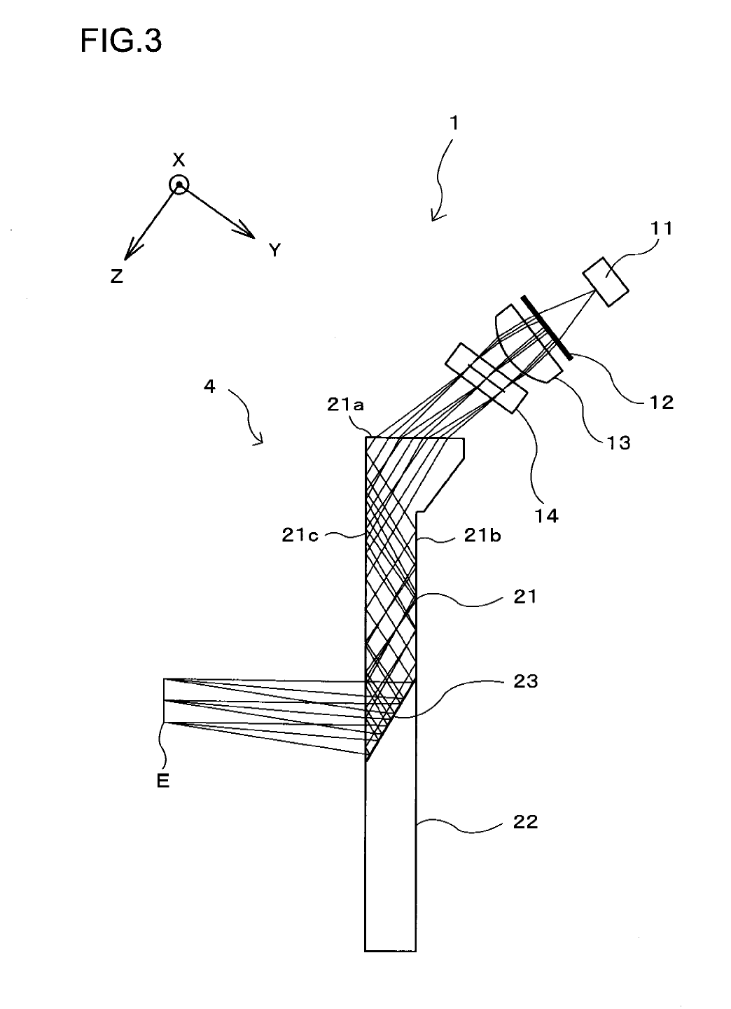

The image display apparatus 1 has a casing 3, which houses at least a light source 11 and a display element 14 (for both, see FIG. 3). The casing 3 holds part of an eyepiece optical system 4. The eyepiece optical system 4 is composed of an eyepiece prism 21 and a deflecting prism 22 bonded together, of which both will be described later, and is as a whole shaped like one lens (in FIG. 2, the one for the right eye) of eyeglasses. The image display apparatus 1 also includes a circuit board (unillustrated) for feeding the light source 11 and the display element 14 with at least drive electric power and an image signal via a cable (unillustrated) through the casing 3.

The supporting member 2 corresponds to the frame of eyeglasses. It holds the image display apparatus 1 (in particular, the eyepiece optical system 4) in front of one eye (for example, the right eye) of a viewer, and holds a dummy lens 5 in front of the other eye (for example, the left eye) of the viewer. The supporting member 2 includes nose pads 6.

When the HMD is mounted on the head of the viewer, and an image is displayed on the display element 14, the light from the image, called the image light or image beam, is directed through the eyepiece optical system 4 to the viewer's pupil. Thus, the viewer can view, as a virtual image, the image presented by the image display apparatus 1. Simultaneously, the viewer can view an outside world image through the eyepiece optical system 4 on a see-through basis. Two image display apparatuses 1 may be used so that the viewer can view the images with both his eyes. Now, the image display apparatus 1 will be described in detail.

### 2. Construction of the Image Display Apparatus

FIG. 3 is a sectional view showing an outline of the construction of the image display apparatus 1. The image display apparatus 1 includes a light source 11, a one-way diffuser plate 12, a condenser lens 13, a display element 14, and the above-mentioned eyepiece optical system 4. The light source 11, the one-way diffuser plate 12, the condenser lens 13, and the display element 14 are housed in the casing 3 shown in FIG. 3, and part of the eyepiece prism 21, which will be described later, is also located in the casing 3.

In the following description, for the sake of convenience of explanation, various directions are defined as follows. The axis that optically connects the center of the display area of the display element 14 to the center of the optical pupil E formed by the eyepiece optical system 4 is the optical axis. The direction of the optical axis as it is when the optical path from the light source 11 to the optical pupil E is straightened is the Z direction. The direction perpendicular to the optical axis incidence surface of a hologram optical element 23, which will be described later, included in the eyepiece optical system 4 is the X direction. The direction perpendicular to the ZX plane is the Y direction. The optical axis incidence surface of the hologram optical element 23 denotes the plane that includes both the optical axis of the light incident on the hologram optical element 23 and the optical axis of the light reflected therefrom; that is, it denotes the YZ plane. In the following description, this optical axis incidence surface is called as such or simply as the incidence surface.

The light source 11 illuminates the display element 14, and is built with RGB-integrated LEDs with three light-emitting portions emitting light of the wavelengths corresponding to three primary colors, namely red (R), green (G), and blue (B), respectively.

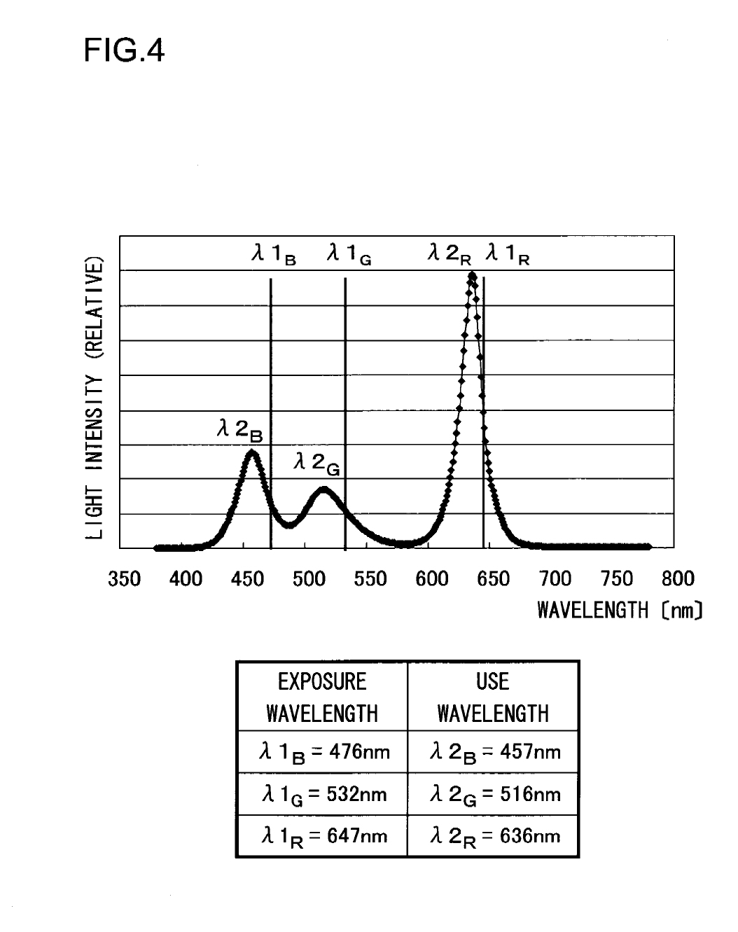

FIG. 4 is an illustrative diagram showing the spectral intensity characteristics of the light source 11, that is, the relationship between the wavelength λ2 of the emitted light and the light intensity (light emission intensity). When the center wavelengths of the B, G, and R light emitted from the light source 11 are represented by λ2_{B}, λ2_{G}, and λ2_{R}, respectively, then here λ2_{B}=457 nm, λ2_{G}=516 nm, and λ2_{R}=636 nm. In FIG. 4, against the vertical axis is plotted the light intensity of B and G light relative to the maximum light intensity of R light.

As described above, the light source 11 is composed of a plurality of light-emitting portions (LEDs) that emit light having light intensity peaks at different wavelengths. Illuminated with this light, the display element 14 can display a color image, which can be presented to the viewer. Since each LED has a narrow light emission wavelength band, using a plurality of such LEDs makes it possible to display a bright image with accurate color reproduction.

The one-way diffuser plate 12 diffuses the light emitted from the light source 11, and exhibits different degrees of diffusion in different directions. More specifically, the one-way diffuser plate 12 diffuses the incident light with an angle of about 40° in the X direction and with an angle of about 0.5° in the Y direction.

The condenser lens 13 is built with a cylinder lens that condenses in the Y direction the light diffused by the one-way diffuser plate 12, and is so arranged that the diffused light forms an optical pupil E efficiently.

The display element 14 modulates the light from the light source 11 according to image data to display an image, and is built with a transmissive liquid crystal display element having pixels arrayed in a matrix to form an area through which light can pass. The display element 14 is arranged with the longer sides of the rectangular display area thereof aligned in the X direction and the shorter sides in the Y direction.

The eyepiece optical system 4 is composed of an eyepiece prism 21 (a first transparent substrate), a deflecting prism 22 (a second transparent substrate), and a hologram optical element 23.

On one hand, the eyepiece prism 21 receives at a surface 21a thereof the image light from the display element 14, and totally reflects it between two opposite surfaces 21b and 21c thereof so as to direct it via the hologram optical element 23 to the viewer's pupil. On the other hand, the eyepiece prism 21 transmits outside light to direct it to the viewer's pupil. The eyepiece prism 21 is, along with the deflecting prism 22, formed of, for example, acrylic resin. The eyepiece prism 21 has the shape of a plane-parallel plate of which a lower-end portion is formed increasingly thin toward the lower end so as to be wedge-shaped and of which a top-end portion is formed increasingly thick toward the upper end. The eyepiece prism 21 is joined to the deflecting prism 22 with adhesive, with the hologram optical element 23, which is arranged at the lower end of the eyepiece prism 21, held between it and the deflecting prism 22.

The deflecting prism 22 is built with a plane-parallel plate that is substantially U-shaped as seen in a front view (see FIG. 2). When bonded to the lower-end portion and both sides (the right and left side surfaces) of the eyepiece prism 21, the deflecting prism 22, together with the eyepiece prism 21, forms a substantially plane-parallel plate. Joining the deflecting prism 22 to the eyepiece prism 21 makes it possible to prevent distortion in the outside world image that the viewer views through the eyepiece optical system 4.

That is, for example, if the deflecting prism 22 is not joined to the eyepiece prism 21, the outside light is refracted when it passes through the wedge-shaped lower-end portion of the eyepiece prism 21, and this produces distortion in the outside world image viewed through the eyepiece prism 21. By contrast, when the deflecting prism 22 is joined to the eyepiece prism 21 to form an integral substantially plane-parallel plate, the refraction that the outside light suffers when passing through the wedge-shaped lower-end portion of the eyepiece prism 21 can be canceled with the deflecting prism 22. In this way, it is possible to prevent distortion in the outside world image viewed on a see-through basis.

The surfaces of the eyepiece prism 21 and the deflecting prism 22 may each be flat or curved. Giving the eyepiece prism 21 and the deflecting prism 22 a curved surface enables the eyepiece optical system 4 to function as an eyesight correction lens.

The hologram optical element 23 is a volume-phase reflection hologram that diffraction-reflects the image light (light of the wavelengths corresponding to the three primary colors) emitted from the display element 14 so as to direct, while enlarging, a virtual image of the image displayed by the display element 14 to the viewer's pupil. The hologram optical element 23 is so produced as to diffract (reflect) light in the following three wavelength bands: 465±5 nm (B light), 521±5 nm (G light), and 634±5 nm (R light), each as expressed in terms of a diffraction efficiency peak wavelength and a diffraction efficiency half-value wavelength width. Here, a diffraction efficiency peak wavelength is the wavelength at which diffraction efficiency exhibits a peak, and a diffraction efficiency half-value wavelength width is the wavelength width within which diffraction efficiency remains higher than or equal to half a peak.

The reflection hologram optical element 23 has high wavelength selectivity such that it only diffraction-reflects light of wavelengths in the above-mentioned wavelength bands. Thus, outside light, which contains light of wavelengths other than those diffraction-reflected, is transmitted through the hologram optical element 23, resulting in high outside light transmissivity.

In addition, the hologram optical element 23 has an axis-asymmetric positive optical power. That is, the hologram optical element 23 functions like an aspherical concave-surface mirror having a positive power. This offers increased flexibility in the arrangement of the individual optical members constituting the apparatus, facilitating the miniaturization thereof, and making it possible to present the viewer with an image with satisfactorily corrected aberrations.

### 3. Operation of the Image Display Apparatus

Next, the operation of the image display apparatus 1 constructed as described above will be described. The light emitted from the light source 11 is diffused by the one-way diffuser plate 12, is then condensed by the condenser lens 13, and then enters the display element 14. Having entered the display element 14, the light is modulated, on a pixel-by-pixel basis, according to image data, and leave the display element 14 as image light. That is, the display element 14 displays a color image.

The image light from the display element 14 then, in the eyepiece optical system 4, enters the eyepiece prism 21 via the upper-end surface (the surface 21a) thereof, is then totally reflected a plurality of times between two opposite surfaces 21b and 21c thereof, and then strikes the hologram optical element 23. Having struck the hologram optical element 23, the light is diffraction-reflected thereon so as to leave the eyepiece prism 21 via a surface 21c thereof and reach the optical pupil E. At the position of the optical pupil E, the viewer can view an enlarged virtual image of the image displayed by the display element 14.

In addition, the eyepiece prism 21, the deflecting prism 22, and the hologram optical element 23 transmit almost all outside light, and thus allow the viewer to view an outside world image therethrough. In this way, the virtual image of the image displayed by the display element 14 is viewed in a form superimposed on part of the outside world image.

As described above, in the image display apparatus 1, the image light emanating from the display element 14 is guided by being totally reflected inside the eyepiece prism 21 so as to be directed via the hologram optical element 23 to the viewer's pupil. Thus, like a common eyeglasses lens, the eyepiece prism 21 and the deflecting prism 22 can be made as thin as about 3 mm, and this helps make the image display apparatus 1 compact and lightweight. In addition, the use of the eyepiece prism 21, which totally reflects inside it the image light from the display element 14, helps obtain high outside light transmissivity, and thus makes it possible to present the viewer with a bright outside world image.

Moreover, the hologram optical element 23 has narrow diffraction efficiency half-value wavelength widths, and offers high diffraction efficiency. Thus, the use of the hologram optical element 23 makes it possible to present a bright image with high color purity, and also offers high outside light transmissivity, allowing the viewer to view a bright outside world image. In addition, the conjugate relationship between the light source 11 and the optical pupil E remains unchanged. This keeps the wavelengths of the image light unchanged, and thus makes it possible to present an image with accurate color reproduction.

As will be understood from the foregoing, the hologram optical element 23 functions as a combiner that directs both the image light from the display element 14 and outside light simultaneously to the viewer's pupil. This allows the viewer to view, via the hologram optical element 23, the image presented by the display element 14 and an outside world image simultaneously.

### 4. Fabrication Method of the Hologram Optical Element

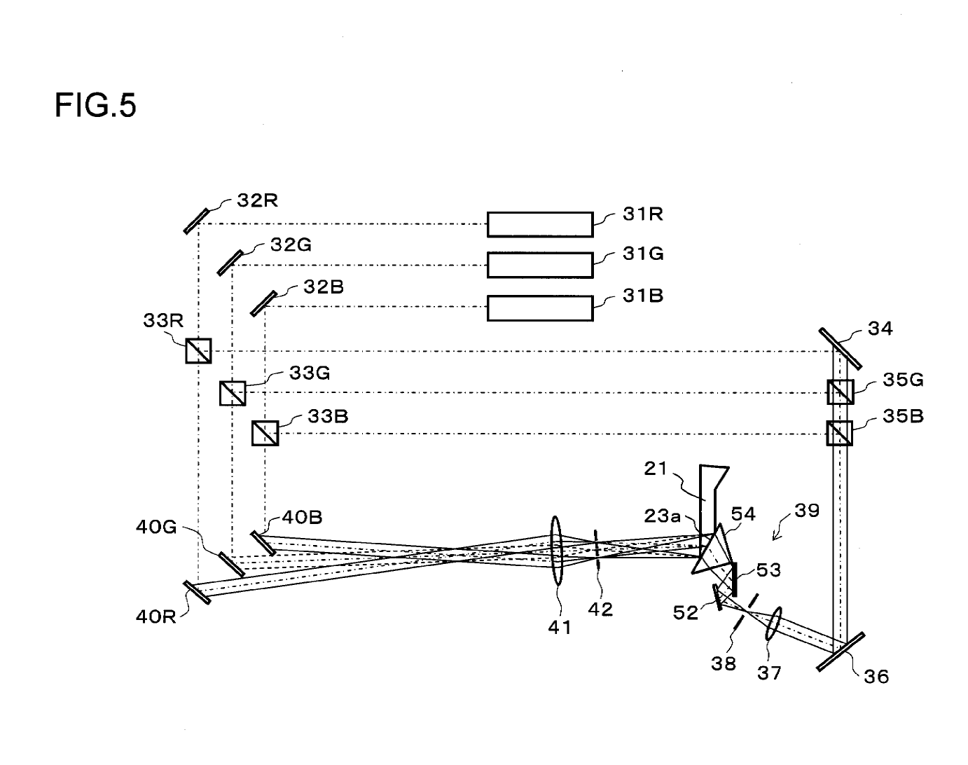

Next, the fabrication method of the hologram optical element 23 described above will be described. FIG. 5 is an illustrative diagram showing an outline of the overall construction of a fabrication optical system used to fabricate the hologram optical element 23. This fabrication optical system includes laser light sources 31R, 31G, and 31B; reflecting mirrors 32R, 32G, and 32B; beam splitters 33R, 33G, and 33B; a reflecting mirror 34; beam combiners 35G and 35B; a reflecting mirror 36; a first condensing optical system 37; a pinhole 38; an object beam producing optical system 39; reflecting mirrors 40R, 40G, and 40B; a second condensing optical system 41; and a pinhole array 42.

The first and second condensing optical systems 37 and 41 are each composed of a plurality of lenses in reality, but are each illustrated as a single lens in FIG. 5. Although omitted in FIG. 5, it is common to provide, immediately following the laser light sources 31R, 31G, and 31B, beam expanders for adjusting the beam diameter to a predetermined diameter and shutters for controlling the laser exposure duration.

In this embodiment, the fabrication optical system is designed as follows: with a view to sharing a single wavefront producing optical system in one side (the object beam producing side) of the fabrication optical system, the phase function of the hologram optical element 23 is set by being optimized with respect to a given color (for example, with respect to G, which has the middle wavelength among R, G, and B). Here, a phase function is a function that represents the difference in phase between the wavefronts of incident light and the wavefronts of diffracted light, and serves as one method whereby to optically define the hologram optical element 23.

The highly coherent R, G, and B laser light beams emitted simultaneously from the laser light sources 31R, 31G, and 31B are deflected by being reflected on the reflecting mirrors 32R, 32G, and 32B, respectively, and are then split, each by the corresponding one of the beam splitters 33R, 33G, and 33B, into two light beams, namely a reference beam and an object beam. The R object beam obtained via the beam splitter 33R is deflected by the reflecting mirror 34; its optical path is then combined by the beam combiner 35G with that of the G object beam obtained via the beam splitter 33G, and is then further combined by the beam combiner 35B with that of the B object beam obtained via the beam splitter 33B.

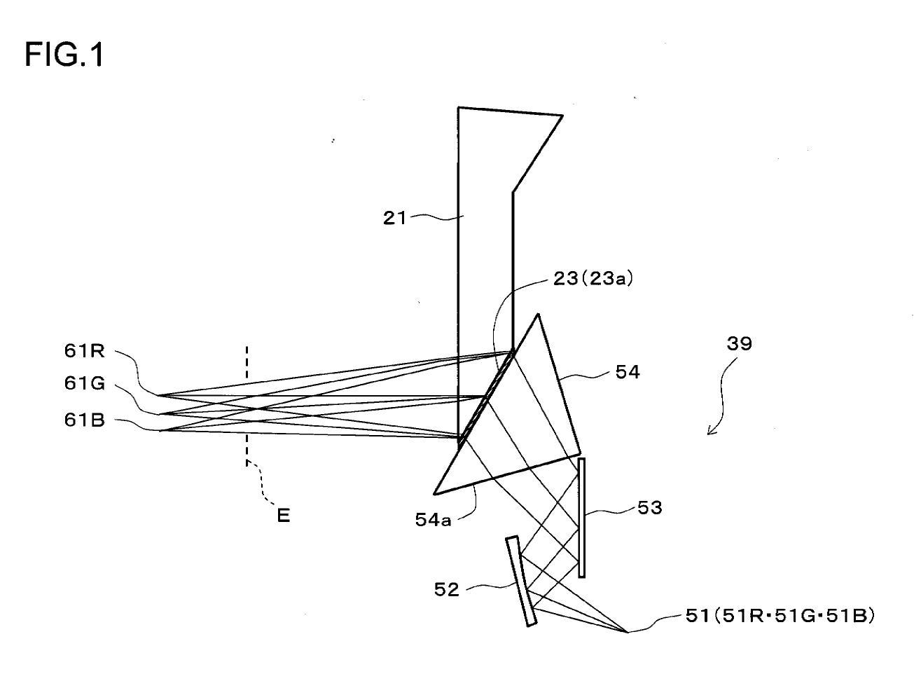

The RGB object beam emanating, as a single light beam, from the beam combiner 35B is deflected by the reflecting mirror 36, is then condensed by the first condensing optical system 37, which is sufficiently corrected for chromatic aberration, so as to be focused as a point light source 51 (see FIG. 1). The point light source 51 is composed of R, G, and B point light sources 51R, 51G, and 51B located at an identical position. At the focus position of the first condensing optical system 37 is arranged the pinhole 38. The light that has passed through the pinhole 38 enters, as an ideal divergent beam from the point light source 51, the object beam producing optical system 39, where the complicated wavefronts (the first wavefronts) of the object beam are produced. The object beam emanating from the object beam producing optical system 39 is shone onto a hologram photosensitive material 23a (photographic recording material) on the eyepiece prism 21 (substrate), from the side opposite from the eyepiece prism 21.

FIG. 1 is an illustrative diagram showing, with enlargement, a principal portion of the fabrication optical system. The object beam producing optical system 39 includes a free-form curved-surface mirror 52, a flat-surface reflecting mirror 53, and a color correction prism 54. The RGB divergent beam from the point light source 51 is formed to have predetermined wavefronts by the free-form curved-surface mirror 52, which has a reflective surface having an optical power, and is then reflected on the flat-surface reflecting mirror 53 so as to enter the color correction prism 54 via a surface 54a (the first refractive surface) thereof. The surface 54a of the color correction prism 54 is arranged at such an angle as to correct for the chromatic aberration occurring as a result of the image light being refracted at the surface 21a (the second refractive surface) of the eyepiece prism 21 used at the time of reconstruction. To prevent ghosts ascribable to surface reflection, it is preferable that the color correction prism 54 be arranged in close contact with the hologram photosensitive material 23a, or with emulsion oil applied in between.

On the other hand, the R, G, and B reference beams obtained via the beam splitters 33R, 33G, and 33B are deflected by the reflecting mirrors 40R, 40G, and 40B, respectively, and then enter the second condensing optical system 41 so as to be focused as point light sources 61R, 61G, and 61B (see FIG. 1) at predetermined different positions, respectively. The second condensing optical system 41 is sufficiently corrected for aberrations even with respect to off-axial rays so that the R, G, and B incident beams are focused at the predetermined focus positions with satisfactory performance.

At the focus position of the second condensing optical system 41 is arranged the pinhole array 42, which has pinholes at the positions of the point light sources 61R, 61G, and 61B. As with the object beam, the divergent beams from the point light sources 61R, 61G, and 61B are shone, as reference beams, onto the hologram photosensitive material 23a from the eyepiece prism 21 side. In this embodiment, as shown in FIG. 1, the point light sources 61R, 61G, and 61B are located farther from the eyepiece prism 21 than is the optical pupil E at the time of reconstruction; that is, they are located on the side of the optical pupil E opposite from the hologram optical element 23, and on a plane substantially parallel to the optical pupil plane.

Moreover, in this embodiment, no optical member having an optical power (for example, cylindrical lens) is arranged between the point light sources 61R, 61G, and 61B and the hologram photosensitive material 23a. Thus, the wavefronts (the second wavefronts) of the R, G, and B reference beams that are shone onto the hologram photosensitive material 23a are spherical wavefronts as propagated from the point light sources 61R, 61G, and 61B, respectively.

As a result of the hologram photosensitive material 23a being exposed, for each color, to two beams, namely the object beam and the reference beam (the first and second wavefronts) as described above, the interference between the two beams produces interference fringes in the hologram photosensitive material 23a, and thus produces the hologram optical element 23. Here, the surface 54a, which produces the first wavefronts, of the color correction prism 54 included in the object beam producing optical system 39 is so designed as to correct for the chromatic aberration occurring as a result of the light directed via a refractive surface (for example, the surface 21a) of the optical system used at the time of reconstruction to the viewer's pupil being refracted at this refractive surface. Thus, exposing the hologram photosensitive material 23a to the first wavefronts produced through the so designed surface 54a makes it possible to reduce the chromatic aberration resulting from refraction at a refractive surface in the optical system used at the time of reconstruction.

In the object beam producing optical system 39, the light from the point light sources 51R, 51G, and 51B is reflected on the free-form curved-surface mirror 52, and is directed via the color correction prism 54 to the hologram photosensitive material 23a. The reflection of the light on the free-form curved-surface mirror 52 helps further reduce unnecessary chromatic aberration.

Considered to be a refractive surface that produces chromatic aberration at the time of reconstruction is not only the surface 21a of the eyepiece prism 21 but also the surface 21c thereof, and also any refractive surface of a lens included in the optical system used at the time of reconstruction. Accordingly, it is advisable that the color correction prism 54 be designed to correct for the chromatic aberration ascribable to those refractive surfaces (the refractive surfaces included in the optical system used at the time of reconstruction). The color correction prism 54 may be composed of a plurality of prisms (may have a plurality of refractive surfaces). A refractive surface included in the color correction prism 54 may be flat or curved.

The above description deals with a case where the R, G, and B laser beams from the laser light sources 31R, 31G, and 31B are emitted simultaneously; it is however also possible to emit them sequentially. The above description deals with a case where the hologram photosensitive material 23a is exposed to an object beam incident from the side of the hologram photosensitive material 23a opposite from the eyepiece prism 21 and to a reference beam incident from the eyepiece prism 21 side; it is however also possible to reverse the relationship between the object beam and the reference beam.

### 5. Details on the Positions of the Reference-Beam-Side Point Light Sources

In this embodiment, with a view to correcting for the chromatic aberration resulting from differences among R, G, and B in the ratio of the exposure wavelength to the use wavelength (light source main wavelength) at the time of reconstruction, the positions of the point light sources 61R, 61G, and 61B are determined based on the considerations described below.

The spectral intensity characteristics of the laser light sources 31R, 31G, and 31B included in the fabrication optical system, that is, the relationship between the exposure wavelength and the light intensity at the time of the fabrication of the hologram optical element 23 is shown, along with the spectral intensity characteristics of the light source 11 at the time of reconstruction, in FIG. 4. As shown there, when the wavelengths of the B, G, and R light emitted from the laser light sources 31B, 31G, and 31R are represented by λ1_{B}, λ1_{G}, and λ1_{R}, respectively, then here λ1_{B}=476 nm, λ1_{G}=532 nm, and λ1_{R}=647 nm. For easy understanding of the following description, typical values for R, G, and B are listed in Table 1 below. The remnant wavelength ratios in Table 1 underlay the fact that, among R, G, and B, the ratio of the exposure wavelength to the use wavelength (the wavelength ratio) differs.

TABLE 1

| | R | G | B |
|---|---|---|---|
| Exposure Wavelength a (nm) | 647 | 532 | 476 |
| Light Source Main Wavelength b (nm) | 636 | 516 | 457 |
| Wavelength Ratio c = b/a | 0.983 | 0.970 | 0.960 |
| Remnant Wavelength Ratio d = c/0.983 | 1.00 | 0.987 | 0.976 |

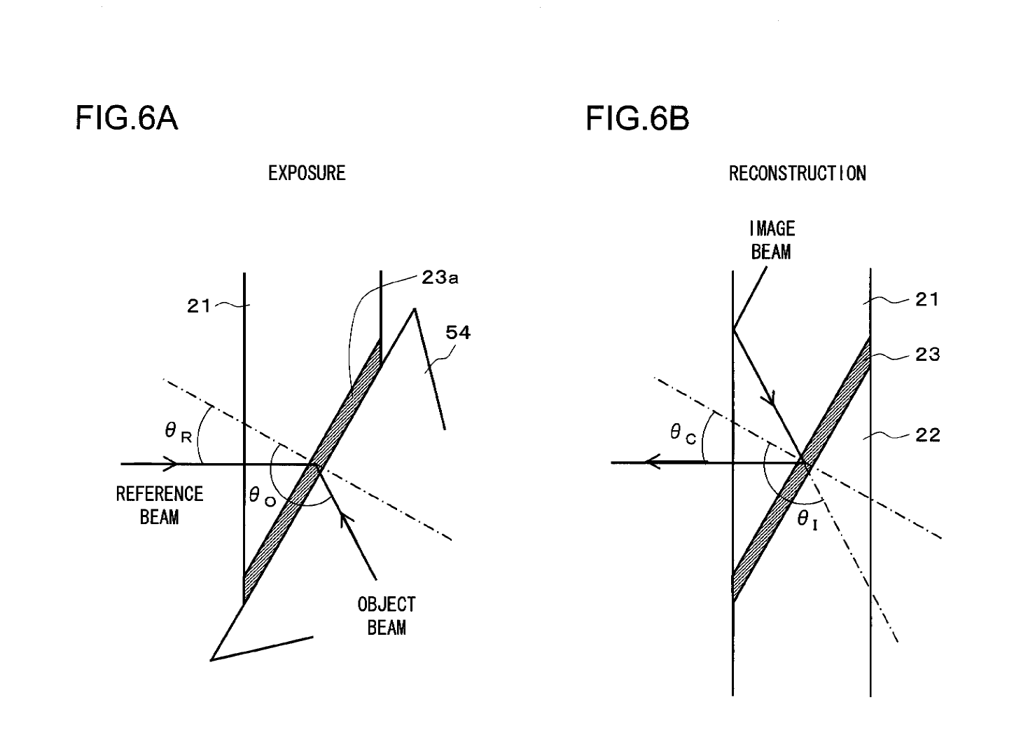

FIG. 6A is an illustrative diagram showing the optical path of the principal ray in the fabrication optical system at the time of the exposure of the hologram photosensitive material 23a, and FIG. 6B is an illustrative diagram showing the optical path of the principal ray at the time of reconstruction (in the use state). Here, the principal ray of the fabrication optical system is the ray that connects the point at which the principal ray in the use state shown in FIG. 6B intersects with the hologram optical element 23 to, on one side, the point light source of the reference beam and, on the other side, the point light source of the object beam. On the other hand, the principal ray in the use state is the ray that emanates from the center of the display screen of the display element 14 (see FIG. 3) and travels toward the center of the optical pupil E.

The angle of incidence of the principal ray of each of the R, G, and B reference beam (the principal ray in the fabrication optical system) needs to be set differently for R, G, and B to fulfill the Bragg's conditions in advance so that, in the use state, the angles (directions) of diffraction at the hologram optical element 23 at the diffraction efficiency peak wavelengths are equal among R, G, and B. The diffraction by the reflection hologram optical element 23 so acts that the light that is diffracted in the direction in which the Bragg's conditions, specifically the following two formulae, simultaneously hold has the maximum diffraction intensity.

(sin θ_{O}−sin θ_{R})/λ_{R}=(sin θ_{I}−sin θ_{C})/λ_{C}

(cos θ_{O}−cos θ_{R})/λ_{R}=(cos θ_{I}−θ_{C})/λ_{C}

where
λ_{R}(nm) represents the fabrication wavelength (exposure wavelength);
θ_{O}(°) represents the angle of incidence of the object beam (object beam angle);
θ_{R}(°) represents the angle of incidence of the reference beam (reference beam angle);
λ_{c}(nm) represents the use wavelength (diffraction wavelength);
θ_{I}(°) represents the angle of incidence of the image principal ray (image beam angle); and
θ_{C}(°) represents the angle of emergence of the image principal ray (line-of-sight angle).
   Here, all the angles θ_{O}, θ_{R}, θ_{I}, and θ_{C} are those as measured in the prism medium.

Substituting specific values in the relevant parameters in the above two conditional formulae to find θ_{R} gives the results listed in Table 2.

TABLE 2

| Exposure Conditions | | | Reconstruction Conditions | | |
|---|---|---|---|---|---|
| | Object | Reference | | Line-of- | Image |
| Exposure | Beam | Beam | Diffraction | sight | Beam |
| Wavelength | Angle | Angle | Wavelength | Angle | Angle |
| λ_{R} (nm) | θ_{O} (°) | θ_{R} (°) | λ_{C} (nm) | θ_{C} (°) | θ_{I} (°) |
| 647 | 150 | 30.00 | 647.00 | 30 | 150 |
| 647 | 150 | 28.30 | 636.00 | 30 | 150 |
| 532 | 150 | 30.00 | 532.00 | 30 | 150 |
| 532 | 150 | 26.97 | 516.00 | 30 | 150 |
| 476 | 150 | 30.00 | 476.00 | 30 | 150 |
| 476 | 150 | 25.96 | 457.00 | 30 | 150 |

Accordingly, in the fabrication optical system, it is advisable that the positions of the point light sources 61R, 61G, and 61B be determined such that the reference beam incidence angle θ_{R} for each of R, G, and B takes the value listed in Table 2 (θ_{R}R=28.30°, θ_{R}G=26.97°, and θ_{R}B=25.96°). More simply, when the difference between the reference beam incidence angle θ_{R}R for R and the reference beam incidence angle θ_{R}G for G is represented by Δθ_{R}(R−G) and the difference between the reference beam incidence angle θ_{R}R for R and the reference beam incidence angle θ_{R}B for B is represented by Δθ_{R}(R−B), then, based on Table 2, these differences are found as

Δθ_{R}(R−G)=28.30−26.97=1.33(°)

Δθ_{R}(R−B)=28.30−25.96=2.34(°)

Accordingly, in the fabrication optical system, it is advisable that the positions of the point light sources 61G and 61B relative to the position of the point light source 61R be determined such that the differences in the principal ray incidence angle between R and G and between R and B are equal to the above values.

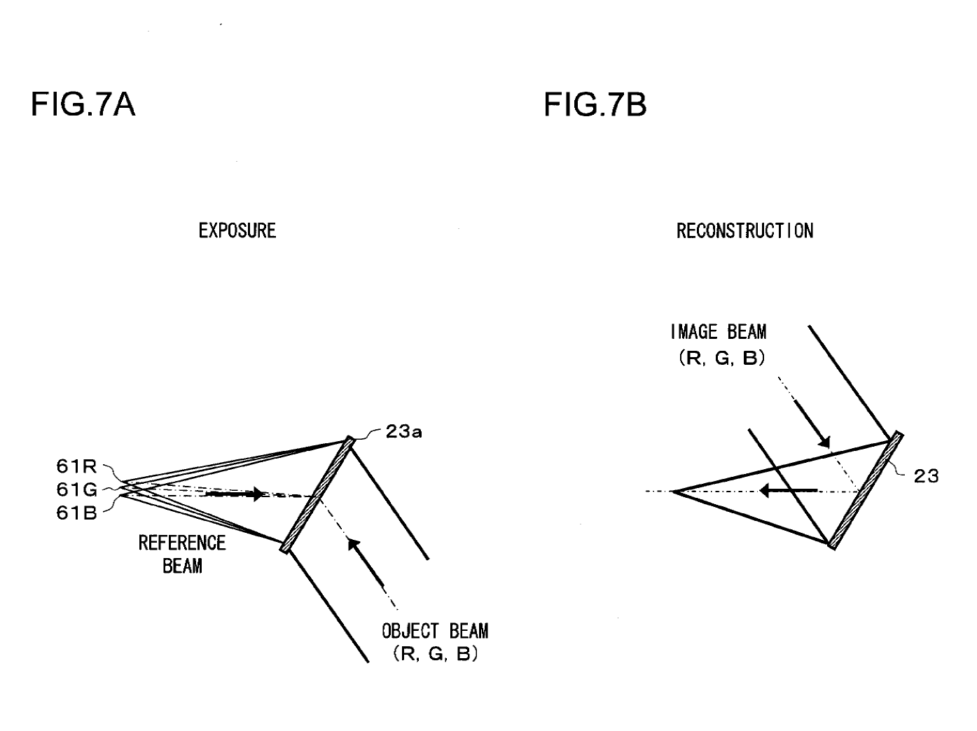

When the point light sources 61R, 61G, and 61B are arranged at positions such that the reference beam incidence angles θ_{R} for R, G, and B are simultaneously equal to the above-shown values as described above, even if the ratio of the exposure wavelength λ_{R} to the use wavelength λ_{C} differs among R, G, and B, it is possible, as shown in FIG. 7B, to make equal among R, G, and B, the angle of diffraction at which the hologram optical element 23 exhibits the maximum diffraction efficiency at the time of reconstruction. In this way, it is possible to reduce the color shifting occurring, due to differences in the ratio of the exposure wavelength λ_{R} to the use wavelength λ_{C}, in the image viewed via the hologram optical element 23 at the time of reconstruction. That is, at the time of use, the viewer can view image light with high diffraction efficiency and with a proper RGB balance, and thus can view a satisfactory image with little color shifting within the screen.

The two conditional formulae noted above can be rearranged to

sin θ_{R}=sin θ_{O}−(λ_{R}/λ_{C})(sin θ_{I}−sin θ_{C})

cos θ_{R}=cos θ_{O}−(λ_{R}/λ_{C})(cos θ_{I}−cos θ_{C})

These conditional formulae show that, provided that the values of θ_{O}, θ_{I}, and θ_{C} each have the same value among R, G, and B, if the wavelength ratio λ_{R}/λ_{C} differs among R, G, and B, then the value of the reference beam incidence angle θ_{R} also differs among R, G, and B (Table 2 proves this in the form of numerical data). Moreover, the differences (Δθ_{R}(R−G) and Δθ_{R}(R−B)) of the reference beam incidence angles θ_{R} for G and B from that for R differ according to the differences (corresponding to the remnant wavelength ratios in Table 1) in the wavelength ratio λ_{R}/λ_{C} between R and G and between R and B; thus, the smaller the remnant wavelength ratio for a color (the larger the difference in the wavelength ratio λ_{R}/λ_{C} differs relative to R), the larger the difference in the reference beam incidence angles θ_{R} relative to R.

Thus, arranging the point light sources 61R, 61G, and 61B at different positions such that, by the degree (angle) corresponding to how the wavelength ratio λ_{R}/λ_{C} differs among R, G, and B, the reference beam incidence angles θ_{R} differs among R, G, and B as in this embodiment, it is possible to surely reduce the color shifting occurring, due to differences in the ratio of the exposure wavelength λ_{R} to the use wavelength λ_{C}, in the image viewed via the hologram optical element 23 at the time of reconstruction.

In this embodiment, at the time of the exposure of the hologram photosensitive material 23a, the eyepiece prism 21 and the hologram photosensitive material 23a can remain stationary (they do not need to be moved for exposure for R, G, and B). This makes it easy to mass-fabricate the hologram optical element 23 with stable optical performance. Thus, by building the image display apparatus 1 by use of the hologram optical element 23 fabricated by the method according to this embodiment, it is possible to make the image display apparatus 1 inexpensive and high-performance.

In the fabrication optical system according to this embodiment, the object-beam-side optical system, which produces complicated wavefronts, is shared among R, G, and B. This allows easy adjustment of the optical system (owing to the absence of adjustment errors that occur independently with R, G, or B), and prevents the performance of wavefronts from varying significantly among R, G, and B.

In this embodiment, no optical member having an optical power is arranged in the optical path between the point light sources 61R, 61G, and 61B and the hologram photosensitive material 23a, so that the spherical wavefronts emitted from the point light sources 61R, 61G, and 61B are used intact as the second wavefronts. The omission of such an optical member helps accordingly simplify the construction of the fabrication optical system and reduce errors in the adjustment of color shifting.

In this embodiment, the point light sources 61R, 61G, and 61B are arranged on a plane that is located on the side of the optical pupil E opposite from the hologram optical element 23 at the time of reconstruction and that is substantially parallel to the optical pupil plane. This arrangement helps alleviate the degradation of the quality of the viewed image even when the position of the viewer's pupil deviates upward or downward within the optical pupil plane. That is, when exposure is performed with the point light sources 61R, 61G, and 61B arranged as described above, if, when the viewer views the image (virtual image) with his pupil placed on the optical pupil plane at the time of reconstruction, the position of the viewer's pupil deviates upward or downward within the optical pupil plane, the direction from which the viewer views, for example, an end part of the image is close to the direction from which light is incident on the corresponding part of the hologram photosensitive material 23a at the time of exposure, and this helps reduce color shifting within the viewing angle.

Incidentally, in a case where, as in the second embodiment described later, an optical path combining member such as a dichroic prism is arranged in the optical path between the point light sources 61R, 61G, and 61B and the hologram photosensitive material 23a, it is advisable that the point light sources 61R, 61G, and 61B be so arranged that, when the optical path of the light traveling from the point light sources 61R, 61G, and 61B via the optical path combining member to the hologram photosensitive material 23a is straightened, the point light sources 61R, 61G, and 61B substantially coincide on a plane substantially parallel to the optical pupil plane.

To summarize the foregoing, the point light sources 61R, 61G, and 61B have to be arranged on a plane optically substantially equivalent to a plane that is located at the side of the optical pupil E opposite from the hologram optical element 23 at the time of reconstruction and that is parallel to the optical pupil plane.

In this embodiment, the hologram photosensitive material 23a is exposed to the R, G, and B light emitted from the laser light sources 31R, 31G, and 31B. That is, the plurality of exposure wavelengths at which the first and second wavefronts are produced correspond to the three primary colors of R, G, and B. This makes it possible to obtain, as the hologram optical element 23, a color hologram optical element that diffraction-reflects R, G, and B light.

The plurality of exposure wavelengths mentioned above do not necessarily have to be all three of the R, G, and B wavelengths, but may be any two of them. Even in such cases, adopting the fabrication method according to this embodiment makes it possible to fabricate a hologram optical element 23 with satisfactorily corrected chromatic aberration.

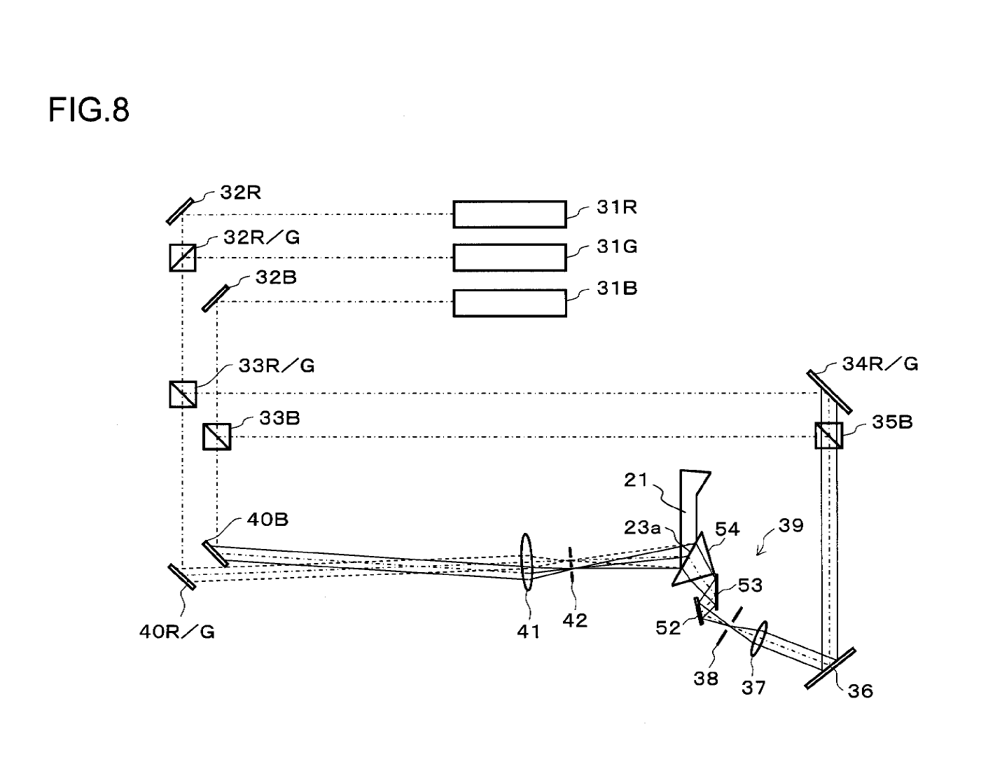

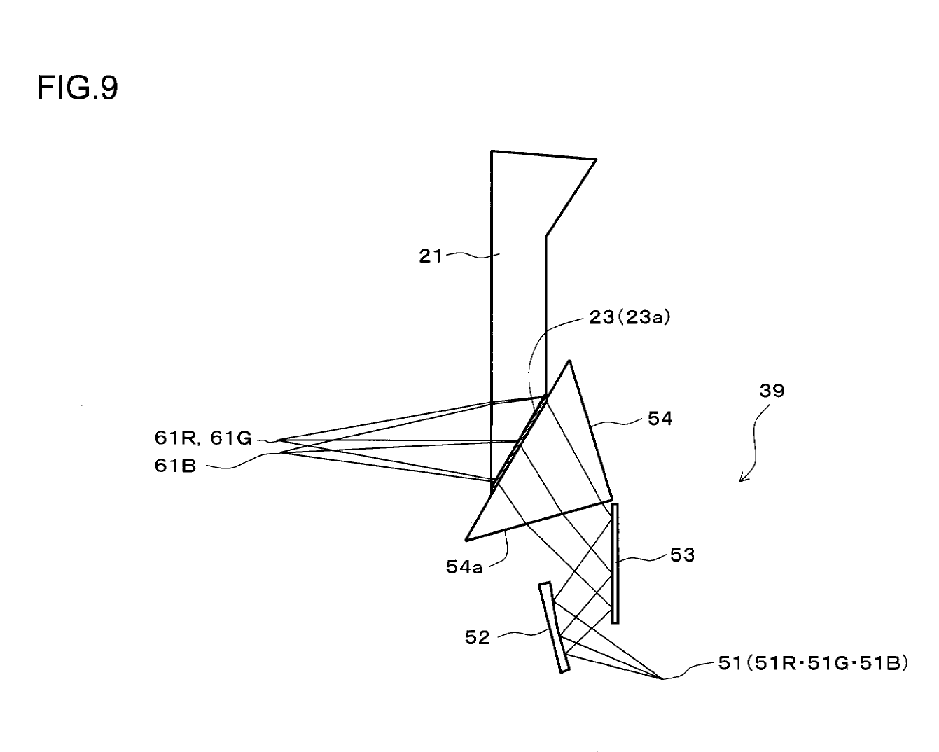

In a case where the ratio of the exposure wavelength to the use wavelength is substantially equal between any two of R, G, and B, the corresponding two of the reference-beam-side point light sources 61R, 61G, and 61B (those for the colors between which the ratio of the exposure wavelength to the use wavelength is substantially equal) may be arranged at an identical position. Now, a fabrication optical system in which the point light sources 61R, 61G, and 61B are arranged in such a way will be described. FIG. 8 is an illustrative diagram showing another example of the construction of the fabrication optical system, and FIG. 9 is an illustrative diagram showing, with enlargement, a principal portion of the fabrication optical system. In this fabrication optical system, it is assumed, as an example, that the reference-beam-side point light sources 61R and 61G substantially coincide in position, and that the point light source 61B is located at a different position from the point light sources 61R and 61G.

In the fabrication optical system shown in FIG. 8, the R laser light beam emitted from the laser light source 31R and reflected on the reflecting mirror 32R and the G laser light beam emitted from the laser light source 31G are combined together by a beam combiner 32R/G. The combined beam is then split into two light beams by a beam splitter 33R/G. One light beam obtained via the beam splitter 33R/G (the R and G object beam) is reflected on a reflecting mirror 34R/G, and its optical path is then combined by a beam combiner 35B with that of the B object beam obtained via the beam splitter 33B; the resulting light beam is then directed to the hologram photosensitive material 23a along the same optical path as in FIG. 1.

On the other hand, the other light beam (the R and G reference beam) obtained via the beam splitter 33R/G is reflected on a reflecting mirror 40R/G, and enters the second condensing optical system 41 so as to be focused as point light sources 61R and 61G at an identical position (see FIG. 9). Likewise, the B reference beam obtained via the beam splitter 33B is reflected on a reflecting mirror 40B, and enters the second condensing optical system 41 so as to be focused as a point light source 61B (see FIG. 9) at a different position from the point light sources 61R and 61G.

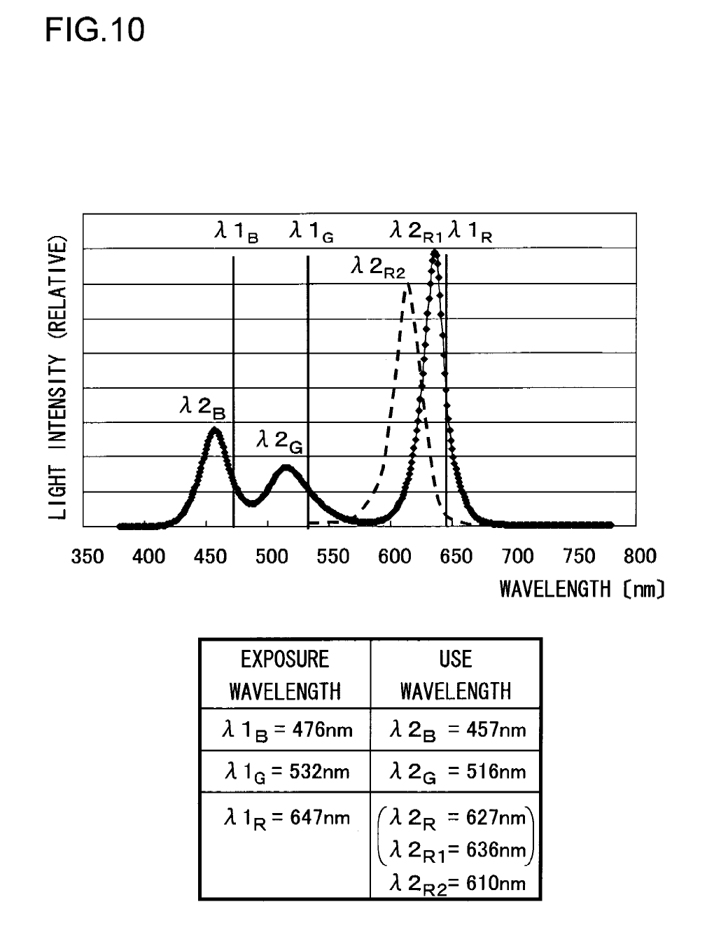

In the light source 11 used at the time of reconstruction, the wavelength width within which light intensity remains higher than or equal to half a peak differs among R, G, and B, and that for R is particularly narrower than those for G and B. As a result, the beam widths of the light beams reaching the optical pupil E at positions above and below where the light beam of the light source main wavelength reaches it differ among the different colors. Thus, at the time of reconstruction, together with the light source 11, an R auxiliary LED having a spectral characteristic as indicated by a broken line in FIG. 10 is additionally used to obtain a wide light-intensity-peak half-value wavelength width for R in total. This helps avoid the above inconvenience.

Here, since the R light intensity peak wavelength λ2_{R1} of the light source 11 is 636 nm, when the light intensity peak wavelength λ2_{R2} of the R auxiliary LED added at the time of reconstruction is, for example, 610 nm, the overall use main wavelength for R will be 627 nm, and hence the ratio of the exposure wavelength to the use (main) wavelength will be 627/647=0.969. This value is substantially equal to the ratio (0.970) of the exposure wavelength to the use wavelength for G. Accordingly, using the R auxiliary LED having the above-mentioned characteristic additionally at the time of reconstruction makes it possible, as shown in FIG. 9, to expose the hologram photosensitive material 23a with the reference-beam-side point light sources 61R and 61G located at an identical position.

In light of the foregoing, in the fabrication optical system, it is advisable that at least two of the point light sources 61R, 61G, and 61B used to produce the second wavefronts (in the example above, the point light sources 61R and 61B, or the point light sources 61G and 61B) be arranged at different positions, and that the point light sources 61R, 61G, and 61B be so arranged that, between the colors corresponding to the two point light sources arranged at different positions (in the above example, between R and B, or between G and B), by the degree corresponding to how the ratio of the exposure wavelength to the use wavelength differs, the angle of incidence on the hologram photosensitive material 23a differs between the light emitted from those two point light sources at the time of exposure.

The hologram photosensitive material 23a used in this embodiment can be formed of, for example, photopolymer. Photopolymer is liable to contract in a process (for example, baking) following exposure, and therefore, in a case where the hologram optical element 23 is formed of such a material, it is preferable to optimize its design with consideration given to its contraction in a post-exposure process.

The amounts of exposure of the hologram photosensitive material 23a to light of different wavelengths can be controlled to be equal, for example, by adjusting the laser intensity. Where sufficient control of the laser intensity is not possible, the amounts of exposure can be controlled by controlling the durations of exposure to light of different colors with shutters.

### Second Embodiment

Another embodiment of the invention will be described below with reference to the relevant drawings. In the following description, for the sake of convenience of explanation, such members as find their counterparts in the first embodiment are identified by common reference signs and no overlapping description will be repeated.

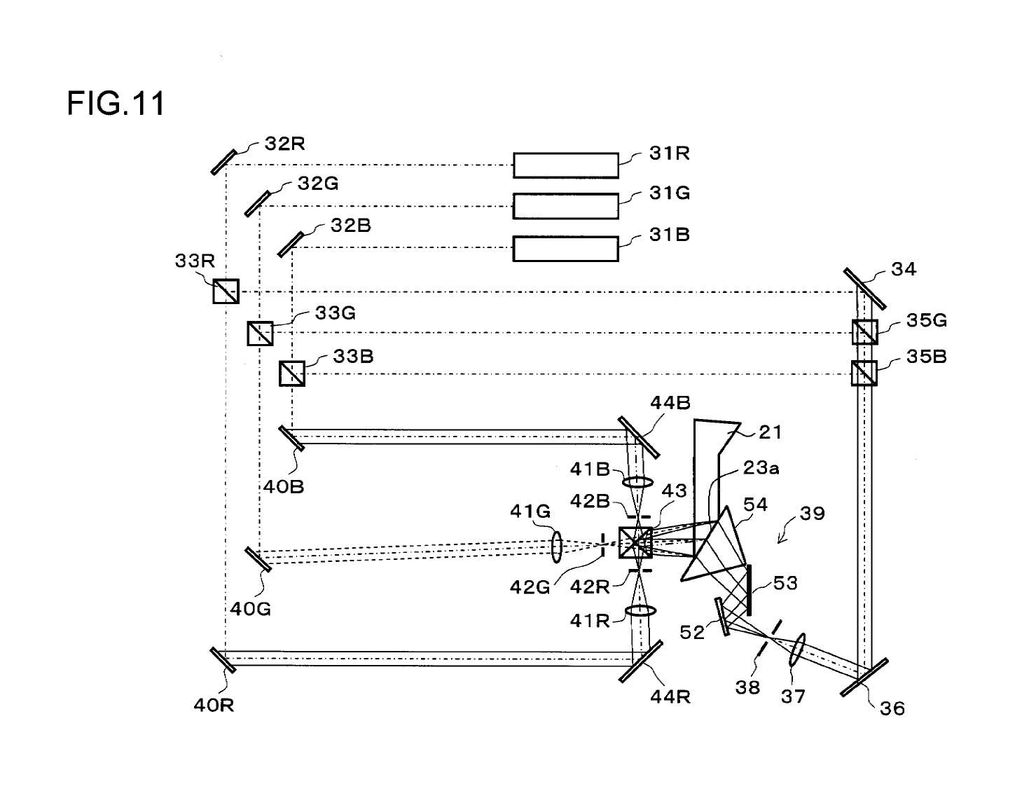

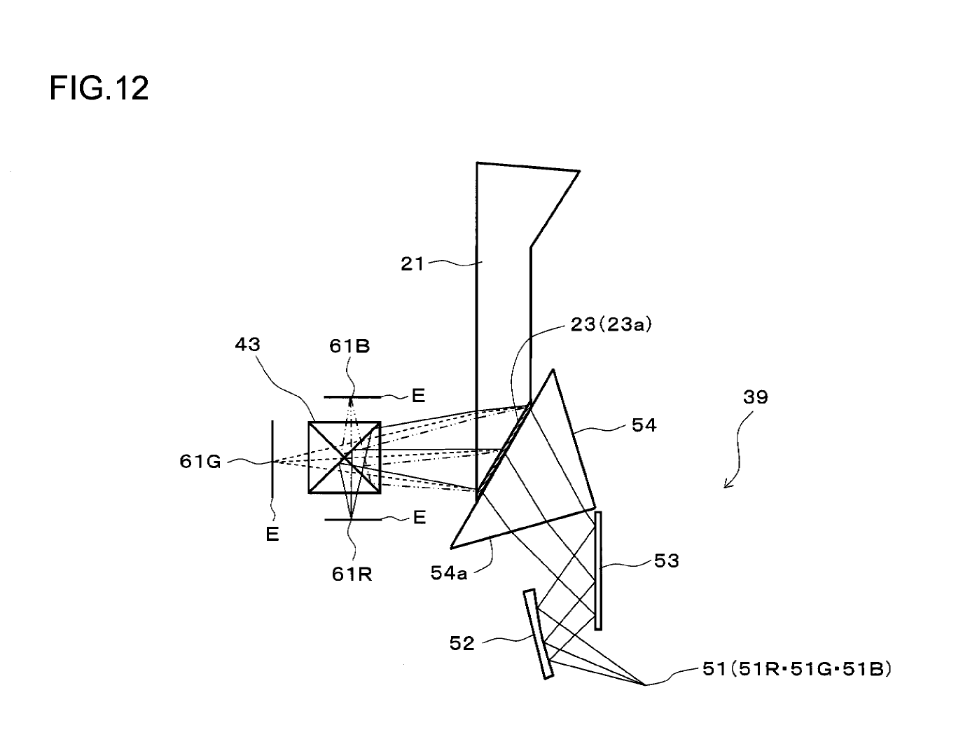

FIG. 11 is an illustrative diagram showing an outline of the overall construction of a fabrication optical system for a hologram optical element 23 according to this embodiment, and FIG. 12 is an illustrative diagram showing, with enlargement, a principal portion of this fabrication optical system. In this fabrication optical system, in place of the second condensing optical system 41 and the pinhole array 42 used in the first embodiment, there are arranged second condensing optical systems 41R, 41G, and 41B and pinholes 42R, 42G, and 42B. The pinholes 42R, 42G, and 42B are respectively arranged at the focus positions of the second condensing optical systems 41R, 41G, and 41B, so as to be located at the positions of the point light sources 61R, 61G, and 61B (see FIG. 12). The positions of the point light sources 61R, 61G, and 61B are optically substantially equivalent to the position of the optical pupil E at the time of reconstruction.

A dichroic mirror 43 (optical path combining member) is arranged in the optical path between the point light sources 61R, 61G, and 61B and the hologram photosensitive material 23a (between the pinholes 42R, 42G, and 42B and the eyepiece prism 21). In addition, a reflecting mirror 44R is arranged in the optical path from the reflecting mirror 40R to the second condensing optical system 41R, and a reflecting mirror 44B is arranged in the optical path from the reflecting mirror 40B to the second condensing optical system 41B. In other respects, the construction here is quite the same as that in the first embodiment shown in FIG. 5.

In the construction described above, the R, G, and B reference beams obtained via the beam splitters 33R, 33G, and 33B are reflected on the reflecting mirrors 40R, 40G, and 40B, respectively. The G reference beam reflected from the reflecting mirror 40G enters the second condensing optical system 41G at a predetermined angle so as to be focused as a point light source 61G at a predetermined position. The R reference beam reflected from the reflecting mirror 40R is reflected on the reflecting mirror 44R and enters the second condensing optical system 41R at a predetermined angle so as to be focused as a point light source 61R at a predetermined position. The B reference beam reflected from the reflecting mirror 40B is reflected on the reflecting mirror 44B and enters the second condensing optical system 41B at a predetermined angle so as to be focused as a point light source 61B at a predetermined position. The light beams emanating from the point light sources 61R, 61G, and 61B enter the dichroic mirror 43 via different surfaces thereof from different directions; their optical paths are combined together in the dichroic mirror 43, and the resulting light beam is shone onto the hologram photosensitive material 23a from the eyepiece prism 21 side.

When the light beams incoming from different directions from the point light sources 61R, 61G, and 61B are combined together in the dichroic mirror 43 so as to be directed together to the hologram photosensitive material 23a as described above, it is possible to arrange the point light sources 61R, 61G, and 61B in positions geometrically, or physically, displaced from one another. This makes it easy to narrow the distances among the point light sources 61R, 61G, and 61B as they are when the optical paths of the light beams emanating from the point light sources 61R, 61G, and 61B are straightened.

In the fabrication optical system of the first embodiment described previously, the point light sources 61R, 61G, and 61B are arranged on the side of the optical pupil E opposite from the hologram optical element 23. These, however, may instead be so arranged that their positions substantially coincide with the position of the optical pupil E. One inconvenience here is that, in a case where the optical pupil E is close to the eyepiece prism 21, if the point light sources 61R, 61G, and 61B are arranged at positions substantially coincident with the position of that optical pupil E, the distances among the point light sources 61R, 61G, and 61B are so small that it is difficult to arrange the pinhole array 42.

By contrast, this embodiment adopts a construction in which the light beams from the point light sources 61R, 61G, and 61B are shone into the dichroic mirror 43 from different directions, and this makes it possible to secure sufficient physical distances among the point light sources 61R, 61G, and 61B. Thus, it is easy to arrange the point light sources 61R, 61G, and 61B (the pinholes 42R, 42G, and 42B) at positions optically equivalent to the position of the optical pupil E.

With the point light sources 61R, 61G, and 61B located at positions optically equivalent to the position of the optical pupil E at the time of reconstruction, when the viewer views, with no deviation in the pupil position within the plane of the optical pupil E, the image (virtual image) presented via the hologram optical element 23 at the time of reconstruction, he can view a satisfactory image without color shifting within the viewing angle.

In an image display apparatus 1 including an adjustment mechanism (for example, the nose pads 6 included in the supporting member 2), the adjustment mechanism allows the viewer's pupil position to be adjusted, and thereby makes it easy to place the viewer's pupil accurately at the center of the optical pupil E. This makes it possible to minimize the color shifting within the screen resulting from a deviation in the position of the viewer's pupil.

As the optical path combining member for combining together the light beams from the point light sources 61R, 61G, and 61B, a dichroic mirror 43 is used in this embodiment. As the optical path combining member, it is possible to use instead, for example, a combiner such as a half-mirror. Using a dichroic mirror 43 makes it possible to combine together light of different wavelengths efficiently and accurately. Moreover, the light beams from the point light sources 61R, 61G, and 61B can then be combined together reliably with a single optical member, namely the dichroic mirror 43. Thus, even if the distance between the point light sources 61R, 61G, and 61B and the eyepiece prism 21 is small, it is possible to combine the optical paths together reliably.

In this embodiment, after the R, G, and B light beams emitted from the laser light sources 31R, 31G, and 31B are each split into two light beams, one of each (the reference beam of each of R, G, and B) is condensed by the corresponding one of the second condensing optical systems 41R, 41G, and 41B so as to serve as the corresponding one of the point light sources 61R, 61G, and 61B. In this fabrication optical system, the second condensing optical systems 41R, 41G, and 41B are arranged one for each of R, G, and B. This makes it possible to adjust the positions of the second condensing optical systems 41R, 41G, and 41B independently for each of R, G, and B, and thus to adjust the focus positions of the R, G, and B light beams in the direction of their travel and in the direction perpendicular thereto. Thus, it is possible to correct for aberrations (for example, axial chromatic aberration) independently for each of R, G, and B.

In a case where a dichroic mirror 43 is used as in this embodiment, the point light sources 61R, 61G, and 61B may be arranged displaced from one another in a direction optically equivalent to the direction perpendicular to the optical pupil plane at the time of reconstruction. In that case, it is possible to correct for color shifting in the direction perpendicular to the optical pupil plane at the time of reconstruction; that is, it is possible to correct for the axial chromatic aberration occurring at the time of reconstruction.

Even in the fabrication optical system of the first embodiment, where no dichroic prism 43 is used, it is possible, for example by partially varying the optical power in the second condensing optical system 41, or by arranging separate pinholes for R, G, and B, to displace the positions of the point light sources 61R, 61G, and 61B in the direction perpendicular to the optical pupil plane at the time of reconstruction.

### Third Embodiment

Yet another embodiment of the invention will be described below with reference to the relevant drawings. In the following description, for the sake of convenience of explanation, such members as find their counterparts in the first or second embodiment are identified by common reference signs and no overlapping description will be repeated.

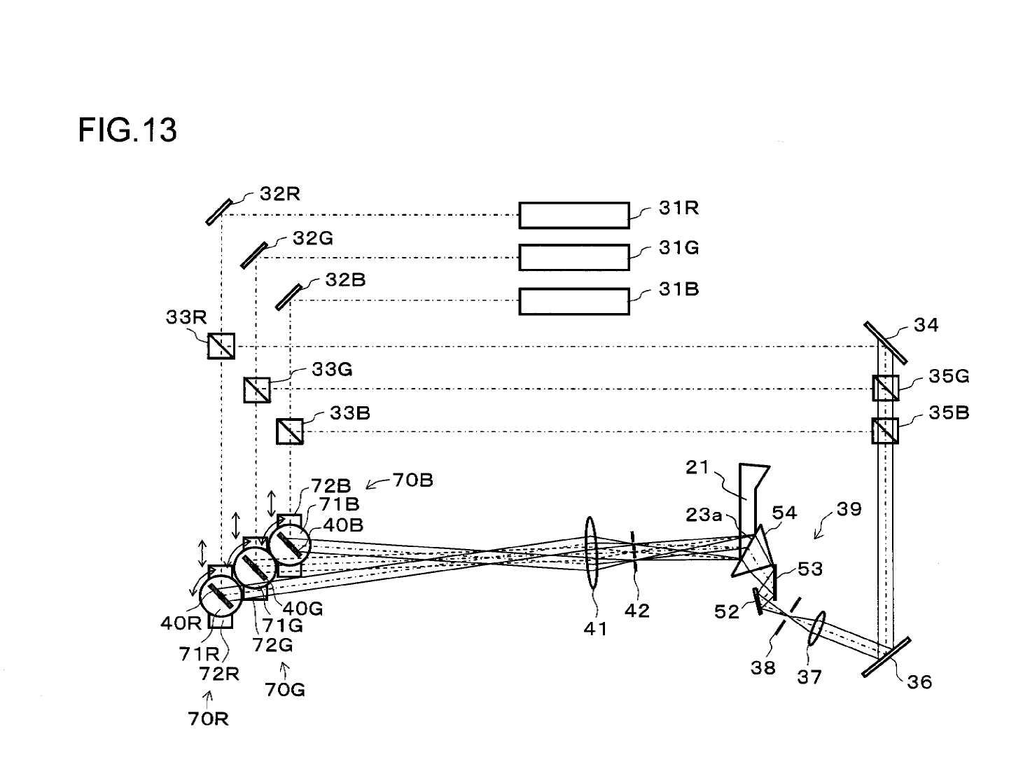

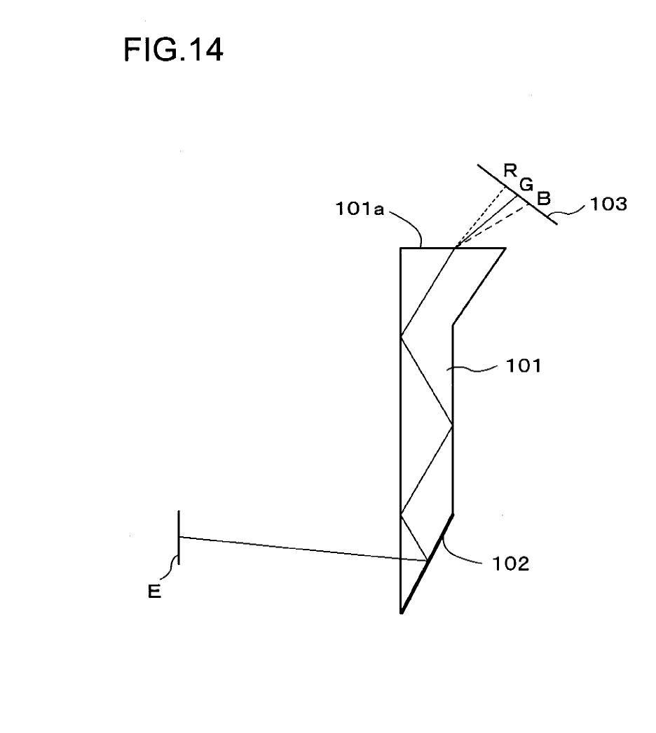

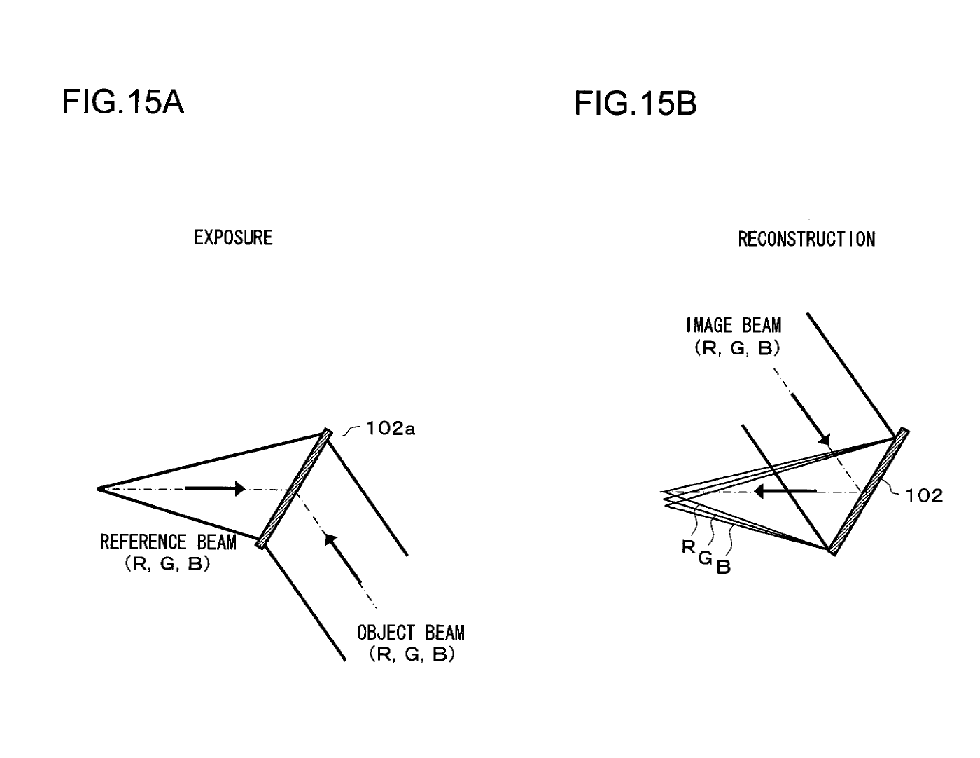

FIG. 13 is an illustrative diagram showing an outline of the overall construction of a fabrication optical system for a hologram optical element 23 according to this embodiment. This fabrication optical system, compared with that of the first embodiment configured as shown in FIG. 5, further includes adjustment stages 70R, 70G, and 70B (an adjustment mechanism).

The adjustment stages 70R, 70G, and 70B are for adjusting the angles of reflection and positions of the reflecting mirrors 40R, 40G, and 40B (deflecting mirrors). More specifically, the adjustment stages 70R, 70G, and 70B are respectively composed of rotation stages 71R, 71G, and 71B and translational stages 72R, 72G, and 72B. The rotational stages 71R, 71G, and 71B themselves rotate and thereby adjust the reflection angles of the reflecting mirrors 40R, 40G, and 40B respectively. The translational stages 72R, 72G, and 72B, while supporting the rotational stages 71R, 71G, and 71B, themselves move two-dimensionally to adjust the positions of the reflecting mirrors 40R, 40G, and 40B two-dimensionally.

In this construction, at the time of exposure, when the R, G, and B reference beams obtained via the beam splitters 33R, 33G, and 33B are reflected on the corresponding reflecting mirrors 40R, 40G, and 40B to enter the second condensing optical system 41, the reflection angles and positions of the reflecting mirrors 40R, 40G, and 40B are adjusted, independently for each of R, G, and B, by the adjustment stages 70R, 70G, and 70B. This makes it easy to fine-adjust the angles of incidence at which the R, G, and B reference beams enter the second condensing optical system 41, and makes it easy to fine-adjust the positions of the point light sources 61R, 61G, and 61B.

Thus, it is easy to fine-adjust the angles of incidence at which the light beams emanating from the point light sources 61R, 61G, and 61B strike the hologram photosensitive material 23a. As a result, even if there is a slight change in the coefficient of contraction of the hologram photosensitive material 23a used at the time of exposure or a slight change in the use wavelength of the light source 11 used at the time of reconstruction, it is easy to cope with such changes. Moreover, even if the assembly accuracy of the fabrication optical system is unsatisfactory, through simple fine-adjustment by use of the adjustment stages 70R, 70G, and 70B, it is possible to place the point light sources 61R, 61G, and 61B at predetermined positions reliably.

Needless to say, different features and methods from different ones of the embodiments described above may be combined appropriately to design a fabrication optical system to fabricate the hologram optical element 23, and to build an image display apparatus or HMD by use of the thus fabricated hologram optical element 23.

The present invention is applicable to the fabrication of color hologram optical elements for use as a combiner in head-mounted displays (HMDs) and head-up displays (HUDs).

The invention may alternatively be expressed as noted below; it then works and offers benefits as noted below.

By a method for fabricating a hologram optical element according to the invention, a volume-phase reflection hologram optical element is formed on a substrate through exposure of a hologram photosensitive material to a first wavefront of a first coherent light beam and a second wavefront of a second coherent light beam. Here, the first wavefront is produced as a result of light emitted, for a plurality of different exposure wavelengths, from a plurality of point light sources (i) located at an identical position traveling through an optical system including at least one refractive surface (first refractive surface), and the refractive surface included in the optical system that produces the first wavefront is so designed as to correct for the chromatic aberration occurring as a result of the light directed to a viewer's pupil being refracted at a refractive surface (second refractive surface) included in the optical system used at the time of reconstruction. On the other hand, the second wavefront is produced by use of light emitted, for a plurality of different exposure wavelengths, from a plurality of point light sources (ii), and at least two of the point light sources (ii) used to produce the second wavefront are arranged at different positions. The point light sources (ii) are so arranged that, as the ratio of the exposure wavelength to the use wavelength at the time of reconstruction differs between the colors corresponding to the two point light sources (ii) that are arranged at different positions, so the angle of incidence on the hologram photosensitive material differs between the light emitted from those two point light sources (ii).

In the above method, the wavefront (first wavefront) of one of the light beams to which the hologram photosensitive material is exposed is produced as a result of light emitted, for a plurality of different exposure wavelengths (for example, corresponding to three colors, namely R, G, and B, or any two of them), from a plurality of point light sources (for example, pinholes) located at an identical position traveling through an optical system including at least one refractive surface. The light beams of the different exposure wavelengths from the point light sources for producing the first wavefront may be emitted simultaneously or sequentially.

Here, the light beams from the point light sources at the time of exposure are refracted by at least one refractive surface (first refractive surface) in the above optical system, and the refraction here corrects for the chromatic aberration occurring as a result of the light (for example, image light) directed to a viewer's pupil being refracted at a refractive surface (second refractive surface) included in the optical system used at the time of reconstruction. What is here referred to as the refractive surface in the optical system used at the time of reconstruction includes, for example in a case where the optical system has a lens, the entrance surface and the exit surface of this lens, and also includes the entrance surface and the total-reflection/transmission surfaces of the substrate on which the hologram optical element is formed. Thus, by exposing the hologram photosensitive material to the first wavefront produced through at least one refractive surface, it is possible to reduce the chromatic aberration resulting from refraction at a refractive surface in the optical system used at the time of reconstruction.

On the other hand, the wavefront (second wavefront) of the other of the light beams to which the hologram photosensitive material is exposed is produced by use of light emitted, for a plurality of different exposure wavelengths, from a plurality of point light sources. For example, the second wavefront may be produced with an optical member having an optical power (for example, a cylindrical lens) arranged between the point light sources and the hologram photosensitive material, or may instead, without additional arrangement of such an optical member, be the wavefront of the spherical wave itself emitted from the point light sources. The light beams of the different exposure wavelengths from the point light sources for producing the second wavefront may be emitted simultaneously or sequentially.

Here, at least two of the point light sources used to produce the second wavefront are arranged at different positions. Specifically, for example in a case where the point light sources are provided one for each of the three colors R, G, and B, the point light sources for R and B may be arranged at different positions (with the point light sources for R and G arranged at an identical position and the point light source for B arranged at a different position), or the point light sources for R, G, and B may be arranged each at a different position. In a case where the point light sources are provided each for one of any two of R, G, and B, the point light sources for those two colors are arranged each at a different position.

Moreover, the point light sources are so arranged that, as the ratio of the exposure wavelength to the use wavelength at the time of reconstruction differs between the colors corresponding to the two point light sources that are arranged at different positions, so the angle of incidence on the hologram photosensitive material differs between the light emitted from those two point light sources. For example, in a case where the point light sources for R and G are arranged at an identical position and the point light source for B is arranged at a different position, the point light sources for R, G, and B are so arranged that, between R and B and between G and B, as the ratio of the exposure wavelength to the use wavelength at the time of reconstruction varies, so the angle of incidence varies. In a case where the point light sources for R, G, and B are arranged each at a different position, the point light sources for R, G, and B are so arranged that, between R and G, between G and B, and between B and R, as the ratio of the exposure wavelength to the use wavelength at the time of reconstruction varies, so the angle of incidence varies (so that the angles of incidence for G and B relative to the angle of incidence for R differ from each other).

With the point light sources arranged as described above, even if the ratio of the exposure wavelength to the use wavelength at the time of reconstruction differs between at least two colors, it is possible to make equal, among all the colors of the point light sources used, the angle of diffraction at which the hologram optical element exhibits the maximum diffraction efficiency at the time of reconstruction. In this way, it is possible to reduce the color shifting occurring in the image (virtual image) viewed through the hologram optical element at the time of reconstruction.

Moreover, it is possible to perform exposure of the hologram photosensitive material without moving the substrate to a different predetermined position for every different color as conventionally practiced. This makes it easy to mass-fabricate a hologram optical element with stable optical performance.

Thus, with the fabrication method according to the invention, it is possible to stably fabricate a hologram optical element that is suitable for mass fabrication, that allows satisfactory simultaneous correction for two kinds of chromatic aberration, and that offers satisfactory optical performance.

In the method for fabricating a hologram optical element according to the invention, the second wavefront may be spherical. In that case, it is possible, without arranging an optical member having an optical power in the optical path between the point light sources used to produce the second wavefront and the hologram photosensitive material, to use the wavefront of the spherical wave emitted from the point light sources intact as the second wavefront. This helps simplify the construction of the fabrication optical system, and helps reduce errors in the adjustment of color shifting.

In the method for fabricating a hologram optical element according to the invention, the point light sources used to produce the second wavefront may be arranged on a plane optically substantially equivalent to the plane that is located on the side of the optical pupil opposite from the hologram optical element at the time of reconstruction and that is parallel to the optical pupil plane. That is, the point light sources may be arranged on a plane that substantially coincides with the plane that is located on the side of the optical pupil opposite from the hologram optical element at the time of reconstruction and that is parallel to the optical pupil plane. In a case where an optical path combining member is arranged in the optical path between the point light sources and the hologram photosensitive material, the point light sources may be so arranged that, when the optical path of the light traveling from the point light sources via the optical path combining member to the hologram photosensitive material is straightened, the point light sources substantially coincide on a plane substantially parallel to the optical pupil plane.

With the above method, even if, when the viewer views the image (virtual image) presented via the hologram optical element with his pupil placed on the optical pupil plane at the time of reconstruction, the position of the viewer's pupil deviates upward or downward within the optical pupil plane, the direction from which the viewer views, for example, an end part of the image is close to the direction from which light is incident on the corresponding part of the hologram photosensitive material at the time of exposure, and this helps reduce color shifting within the viewing angle.

In the method for fabricating a hologram optical element according to the invention, the point light sources used to produce the second wavefront may be arranged at a position optically substantially equivalent to the position of the optical pupil at the time of reconstruction. That is, the point light sources may be arranged so as to substantially coincide with the position of the optical pupil at the time of reconstruction. In a case where an optical path combining member is arranged in the optical path between the point light sources and the hologram photosensitive material, the point light sources may be so arranged that, when the optical path of the light traveling from the point light sources via the optical path combining member to the hologram photosensitive material is straightened, the point light sources substantially coincide with the position of the optical pupil plane.

With the above method, when the viewer views, with no deviation in the pupil position within the plane of the optical pupil, the image (virtual image) presented via the hologram optical element at the time of reconstruction, he can view a satisfactory image without color shifting within the viewing angle.

In the method for fabricating a hologram optical element according to the invention, the point light sources used to produce the second wavefront may be arranged displaced in a direction optically equivalent to the direction perpendicular to the optical pupil plane at the time of reconstruction. That is, the point light sources may be arranged displaced in the direction perpendicular to the optical pupil plane at the time of reconstruction. In a case where an optical path combining member is arranged in the optical path between the point light sources and the hologram photosensitive material, the point light sources may be so arranged that, when the optical path of the light traveling from the point light sources via the optical path combining member to the hologram photosensitive material is straightened, the point light sources are displaced in the direction perpendicular to the optical pupil plane. With this method, it is possible to correct for color shifting in the direction perpendicular to the optical pupil plane at the time of reconstruction; that is, it is possible to correct for the axial chromatic aberration occurring at the time of reconstruction.

In the method for fabricating a hologram optical element according to the invention, an optical path combining member may be arranged between the point light sources used to produce the second wavefront and the hologram photosensitive material so that the light incoming from different directions from the point light sources is combined together with the optical path combining member and then the resulting light is directed to the hologram photosensitive material.

With this method, the light emanating from the point light sources is directed via the optical path combining member to the hologram photosensitive material, and this makes it possible to arrange the point light sources in positions geometrically displaced from one another. This makes it easy to narrow the distances among the point light sources as they are when the optical path of the light emanating from the point light sources is straightened.

In the method for fabricating a hologram optical element according to the invention, the light emitted from each of the laser light sources corresponding to the different exposure wavelengths may be split into two beams, of which one is then condensed by the corresponding one of the condensing optical systems corresponding to the different exposure wavelengths so as to serve as the corresponding one of the point light sources used to produce the second wavefront.

With this method, the condensing optical systems are arranged one for each of the different exposure wavelengths (for example, corresponding to the three colors R, G, and B). This makes it possible to adjust the positions of the condensing optical systems independently for each of the different exposure wavelengths, and thus to correct for aberrations (for example, axial chromatic aberration) independently for each of the different exposure wavelengths.

In the method for fabricating a hologram optical element according to the invention, the optical path combining member may be a dichroic prism. In that case, the light from the point light sources can be combined together reliably with a single optical member, namely the dichroic mirror. Thus, even if the distance between the point light sources and the substrate (the optical member on which the hologram optical element is formed) is small, it is possible to combine optical paths together reliably.

In the method for fabricating a hologram optical element according to the invention, when the light emitted from each of the laser light sources corresponding to the different exposure wavelengths is split into two beams and one of these beams is then reflected by the corresponding one of the deflecting mirrors corresponding to the different exposure wavelengths and is then condensed so as to serve as the corresponding one of the point light sources (ii) used to produce the second wavefront, the angles of reflection and positions of the deflecting mirrors may be adjusted with an adjustment mechanism.

With this method, through adjustment of the angles of reflection and positions of the deflecting mirrors with the adjustment mechanism, it is possible to easily adjust the angle of incidence at which the light emanating from the point light sources strikes the hologram photosensitive material. Thus, even if there is a slight change in the coefficient of contraction of the hologram photosensitive material (for example, photopolymer) used at the time of exposure or a slight change in the use wavelength of the light source used at the time of reconstruction, it is easy to cope with such changes.

In the method for fabricating a hologram optical element according to the invention, the light from the point light sources used to produce the first wavefront may be directed to the hologram photosensitive material via a reflective surface having an optical power and via the above refractive surface (first refractive surface).

With this method, in the optical system for producing the first wavefront, when the light emanating from the point light sources is directed via the refractive surface to the hologram photosensitive material, the light is reflected on the reflective surface (for example, a free-form curved-surface mirror) having an optical power provided within the optical system. This helps reduce unnecessary chromatic aberration.

In the method for fabricating a hologram optical element according to the invention, the plurality of exposure wavelengths at which the first and second wavefront are produced may be wavelengths corresponding to three primary colors. In that case, the hologram photosensitive material is exposed to R, G, and B light, and this makes it possible to fabricate a color hologram optical element that diffraction-reflects R, G, and B light.

A hologram optical element according to the invention may be fabricated by the above-described fabrication method according to the invention. This makes it possible to realize a hologram optical element with satisfactory optical performance.

An image display apparatus according to the invention is provided with: a display element displaying an image; a substrate through which the image light from the display element is guided by total reflection; and a volume-phase reflection hologram optical element formed on the substrate and diffraction-reflecting and thereby directing the image light having been guided through the substrate to a viewer's pupil. Here, the hologram optical element may be the above-mentioned hologram optical element according to the invention.

With the fabrication method according to the invention, it is possible to stably fabricate a hologram optical element that is suitable for mass fabrication and that offers satisfactory optical performance. Thus, by building an image display apparatus by combining the thus fabricated hologram optical element with a substrate and a display element, it is possible to realize an inexpensive, high-performance image display apparatus.

In the image display apparatus according to the invention, the hologram optical element may be a combiner that directs, along with the image light from the display element, outside light simultaneously to the viewer's pupil. In that case, the viewer can view (as a virtual image) the image displayed by the display element and simultaneously an outside world image. Thus, it is possible to realize an image display apparatus of a see-through type.

It should be understood that any embodiments, examples, and the like specifically described herein are merely intended to clarify the technical features of the invention and thus are not intended to limit in any way the interpretation of the invention; that is, the invention may be put into practice with any modifications and variations made within the scope of the appended claims.

What is claimed is:

1. A method for fabricating a hologram optical element, comprising:
a step (a) of forming a volume-phase reflection hologram optical element on a substrate through exposure of a hologram photosensitive material to a first wavefront of a first coherent light beam and a second wavefront of a second coherent light beam,
wherein
the first wavefront is produced as a result of light emitted, for a plurality of different exposure wavelengths, from a plurality of point light sources (i) located at an identical position traveling through an optical system including at least one refractive surface,
the refractive surface included in the optical system that produces the first wavefront is so designed as to correct for chromatic aberration occurring as a result of light directed to a viewer's pupil being refracted at a refractive surface included in an optical system used at time of reconstruction,
the second wavefront is produced by use of light emitted, for a plurality of different exposure wavelengths, from a plurality of point light sources (ii),
at least two of the point light sources (ii) used to produce the second wavefront are arranged at different positions, and
the point light sources (ii) are so arranged that, as a ratio of an exposure wavelength to a use wavelength at time of reconstruction differs between colors corresponding to two point light sources (ii) that are arranged at different positions, so an angle of incidence on the hologram photosensitive material differs between light emitted from those two point light sources (ii).

2. The method according to claim 1,
wherein the second wavefront is spherical.

3. The method according to claim 1,
wherein the point light sources (ii) used to produce the second wavefront are arranged on a plane optically substantially equivalent to a plane that is located on a side of an optical pupil opposite from the hologram optical element at time of reconstruction and that is parallel to an optical pupil plane.

4. The method according to claim 1,
wherein the point light sources (ii) used to produce the second wavefront are arranged at a position optically substantially equivalent to a position of an optical pupil at time of reconstruction.

5. The method according to claim 1,
wherein the point light sources (ii) used to produce the second wavefront are each arranged displaced in a direction optically equivalent to a direction perpendicular to an optical pupil plane at time of reconstruction.

6. The method according to claim 1,
wherein
an optical path combining member is arranged between the point light sources (ii) used to produce the second wavefront and the hologram photosensitive material, and
the method further comprises a step (b) of combining together the light incoming from different directions from the point light sources (ii) with the optical path combining member and directing resulting light to the hologram photosensitive material.

7. The method according to claim 6,
wherein, in the step (b), light emitted from each of laser light sources corresponding to the different exposure wavelengths is split into two beams, of which one is then condensed by a corresponding one of condensing optical systems corresponding to the different exposure wavelengths so as to serve as a corresponding one of the point light sources (ii) used to produce the second wavefront.

8. The method according to claim 6,
wherein the optical path combining member is a dichroic prism.

9. The method according to claim 1,
wherein
light emitted from each of laser light sources corresponding to the different exposure wavelengths is split into two beams, of which one is then reflected by a corresponding one of deflecting mirrors corresponding to the different exposure wavelengths and is then condensed so as to serve as a corresponding one of the point light sources (ii) used to produce the second wavefront, and
the method further comprises a step (c) of adjusting angles of reflection and positions of the deflecting mirrors with an adjustment mechanism.

10. The method according to claim 1, further comprising:
a step (d) of directing the light from the point light sources (i) used to produce the first wavefront to the hologram photosensitive material via a reflective surface having an optical power and via the refractive surface.

11. The method according to claim 1,
wherein the plurality of exposure wavelengths at which the first and second wavefront are produced are wavelengths corresponding to three primary colors.

12. A hologram optical element fabricated by the method according to claim 1.

13. An image display apparatus comprising:
a display element displaying an image;
a substrate through which image light from the display element is guided by total reflection; and
a volume-phase reflection hologram optical element formed on the substrate and diffraction-reflecting and thereby directing the image light having been guided through the substrate to the viewer's pupil,
wherein the hologram optical element is the hologram optical element according to claim 12.

14. The image display apparatus according to claim 13,
wherein the hologram optical element is a combiner that directs, along with the image light from the display element, outside light simultaneously to the viewer's pupil.

15. A head-mounted display comprising:
the image display apparatus according to claim 13; and
a supporting member supporting the image display apparatus in front of the viewer's eye.
